(19) United States
(12) Patent Application Publication
(10) Pub. No.: US 2025/0276608 A1
(43) Pub. Date: Sep. 4, 2025

(54) DEVICES, SYSTEMS AND METHODS FOR INTERFACING BETWEEN ELECTRICALLY POWERED VEHICLES AND USER DEVICES

(71) Applicant: CYKEL TECHNOLOGIES INC., Vancouver (CA)

(72) Inventors: Daniel Godfrey, Torquay (GB); Simon Chapman, Vancouver (GB)

(21) Appl. No.: 19/068,743

(22) Filed: Mar. 3, 2025

Related U.S. Application Data
(60) Provisional application No. 63/560,492, filed on Mar. 1, 2024.

(51) Int. Cl. B60L 58/10; B60K 35/21; B60R 16/03; G07C 5/08; H04W 4/40; H04W 4/80

(52) U.S. Cl. CPC B60L 58/10; B60K 35/21; B60R 16/03; G07C 5/08; H04W 4/40; H04W 4/80; B60K 2360/169

(57) ABSTRACT

Described are various embodiments of devices, systems and methods for interfacing between electrically powered vehicles and user devices; and optionally determining usage insights associated with a fleet of electrically powered vehicles.

### FIELD OF THE DISCLOSURE

The present disclosure relates to technology for electrically powered vehicles and in particular, to various embodiments of devices, systems and methods for interfacing between electrically powered vehicles and user devices, and optionally generating electrically powered vehicle insights based on data acquired therefrom.

### BACKGROUND

Electrically powered vehicles, including electric bicycles or e-bikes, are increasing in popularity due to the fact that they emit zero combustion by-products. Approximately 1.4 million personal e-bikes were sold in the United States and Canada in 2022. Most e-bikes are manufactured by a handful of original manufacturers, differing mainly in physical attributes. E-bikes typically use rechargeable batteries in addition to electric motors and some form of control.

E-bikes are typically provided with an integral display, to provide users with information related to the e-bike, such as battery level, speed, or the like. Other e-bikes allow for the retrofitting of such displays to enhance user experience.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for devices, systems and methods for interfacing between electrically powered vehicles and user devices, that overcome some of the drawbacks of known techniques, or at least, provides a useful alternative thereto. Some aspects of this disclosure provide examples of such devices, systems and methods.

In accordance with one aspect, there is provided a data interfacing system for electrically powered vehicles comprising: a processor; one or more electrical signal interfaces in communication with the processor, the one or more electrical signal interfaces interfaceable with a control system of an electrically powered vehicle and configured to receive from the control system vehicle data comprising at least one of vehicle battery level and vehicle operational information; one or more operational sensors for detecting motion and/or location of the electrically powered vehicle; one or more short-range wireless communication interfaces in communication with the processor and configured to communicate with, using a short-range, low-power communications protocol: a software-enabled human interface device; and one or more proximate locationally-aware nodes on an existing global mesh network of locationally-aware nodes configured for communication using the short-range, low-power communications protocol, the one or more proximate locationally-aware nodes further configured to communicate location data of the electrically-powered vehicle to the software-enabled human interface device; and a power source that provides electrical power for continuous operation of the data interfacing system.

In one embodiment, one or more electrical signal interfaces comprises an electrical connector connectable to a corresponding connector of the control system.

In one embodiment, the electrical connector is in the form of a four-or five-pin connector which is connectable to a plurality of distinctly manufactured control systems.

In one embodiment, the one or more electrical signal interfaces comprises an operational input connector connectable to a corresponding operational connector of an operational input device of the electrically powered vehicle.

In one embodiment, the processor is configured to receive via the one or more short-range wireless communication interfaces external sensor data from an external sensor device.

In one embodiment, the processor is configured to communicate both the vehicle data and the external sensor data to the software-enabled human interface device for concurrent display.

In one embodiment, the software-enabled human interface device and/or the data interfacing system forms a centralized data hub which replaces an original display of the electrically powered vehicle.

In one embodiment, the data interfacing system further comprises a visual indicator connected to the processor and configured to visually indicate the vehicle battery level of the electrically powered vehicle independent of the software-enabled human interface device.

In one embodiment, the software-enabled human interface device comprises a data communication interface.

In one embodiment, the software-enabled human interface device comprises at least one of: one or more sensor components, a visual display, and a touch screen data input component.

In one embodiment, the continuous operation of the data interfacing system includes any one or combination of: during periods of non-use of the electrically powered vehicle; during periods when the electrically powered vehicle has a depleted battery; and/or during periods when the software-enabled human interface device is not proximate the electrically powered vehicle.

In one embodiment, the software-enabled human interface device is configured to execute one or more pre-existing software components utilizing data from at least one of: the control system, the one or more operational sensors, one or more external sensor devices, a peripheral user input device, and the location data.

In one embodiment, rapid deceleration is detected by at least one of: the one or more operational sensors, one or more sensors forming part of said software-enabled human interface device, one or more sensors forming part of or associated with said electrically powered vehicle, and the communication with the one or more proximate locationally-aware nodes.

The data interfacing system of claim 13, wherein the processor is configured to communicate a crash alert upon the rapid deceleration exceeding a deceleration safety threshold.

In one embodiment, the crash alert is communicated to predetermined contact information.

In one embodiment, the crash alert is communicated via the one or more proximate locationally-aware nodes on the existing global mesh network to the predetermined contact information.

In one embodiment, the crash alert comprises the location data.

In one embodiment, to detect motion when the data interfacing system is not in communication range with the software-enabled human interface device, the motion is detected by at least one of: the one or more operational sensors, one or more sensors forming part of or associated with the electrically powered vehicle, and the communication with the one or more proximate locationally-aware nodes.

In one embodiment, the processor is configured to communicate a theft alert upon the motion outside the communication range with the software-enabled human interface device being detected as exceeding a predetermined radial threshold.

In one embodiment, the theft alert is communicated to predetermined contact information.

In one embodiment, the theft alert is communicated to the software-enabled human interface device.

In one embodiment, the theft alert is communicated via the one or more proximate locationally-aware nodes on the existing global mesh network to the predetermined contact information.

In one embodiment, the theft alert comprises the location data.

In one embodiment, the processor is configured to communicate a maintenance alert based on data from at least one of: the one or more operational sensors, human interface device sensors, and the communication with the one or more proximate locationally-aware nodes.

In one embodiment, the maintenance alert is based on at least one of: an amount of time the electrically powered vehicle is in operation, an amount of time the electrically powered vehicle is not in motion, an amount of time since a prior maintenance event, a theft alert, a crash alert, vehicle power status, and vehicle operational information.

In accordance with another aspect, there is provided a data interfacing system for electrically powered vehicles comprising: a processor; one or more electrical signal interfaces in communication with the processor, configured to interface with and receive from a control system of an electrically powered vehicle predefined vehicle data comprising at least one of vehicle battery level and vehicle operational information; one or more operational sensors for detecting motion and/or location of the electrically powered vehicle; one or more short-range wireless communication interfaces configured to communicate with, using a short-range, low-power communications protocol: a software-enabled human interface device; and one or more proximate locationally-aware nodes on an existing global mesh network of locationally-aware nodes configured for communicating on the short-range, low-power communications protocol, and further configured to communicate location data to the software-enabled human interface device.

In one embodiment, the data interfacing system is retrofittable to the electrically powered vehicle to replace an original display of the electrically powered vehicle.

In accordance with another aspect, there is provided a data interfacing system for electrically powered vehicles comprising: a processor; one or more electrical signal interfaces in communication with the processor for interfacing with a control system for an electrically powered vehicle, the one or more electrical signal interfaces configured to receive vehicle data from the control system comprising at least one of vehicle battery level and vehicle operational information; one or more operational sensors for detecting motion and/or location of the electrically powered vehicle; and one or more short-range wireless communication interfaces configured to communicate with, using a short-range, low-power communications protocol, a software-enabled human interface device; and a power source that provides electrical power for continuous operation of the data interfacing system during predefined periods.

In accordance with another aspect, there is provided a data interfacing system for electrically powered vehicles comprising: a processor; one or more electrical signal interfaces in communication with the processor, the one or more electrical signal interfaces interfaceable with a control system of an electrically powered vehicle and configured to receive data from the control system; one or more short-range wireless communications interfaces in communication with the processor and configured to communicate with, using a short-range, low-power communications protocol, a software-enabled human interface device; wherein the one or more short-range wireless communications interfaces is further configured to communicate with, using the short-range, low-power communications protocol, one or more external sensor devices, such that any external sensor data is communicable to the software-enabled human interface device via the short-range, low-power communications protocol; and a power source that provides electrical power for continuous operation of the data interfacing system.

In one embodiment, the data interfacing system forms a centralized data hub and wherein the one or more external sensor devices are wirelessly connected to the centralized data hub.

In accordance with another aspect, there is provided a data interfacing device for an electrically powered vehicle comprising: a processor; a first electrical signal interface in communication with the processor, the first electrical signal interface interfaceable with a control system of the electrically powered vehicle and configured to receive from the control system vehicle data comprising at least one of vehicle battery level and vehicle operational information; a second electrical signal interface in communication with the processor, the second electrical signal interface interfaceable with a user input system of the electrically powered vehicle and configured to receive from the user input system vehicle input data comprising at least vehicle control commands; at least one short-range wireless communication interface in communication with the processor and configured to communicate via a short-range, low-power communications protocol with a software-enabled human interface device, such that both the vehicle data and the vehicle input data are wirelessly communicable to the software-enabled human interface device; and a power source that provides electrical power for continuous operation of the data interfacing system.

In one embodiment, the at least one short-range wireless communication interface is further communicably linked with any one or both of: one or more external sensor devices; and one or more proximate locationally-aware nodes on an existing global mesh network of locationally-aware nodes configured for communication using the short-range, low-power communications protocol.

In one embodiment, the data interfacing device is configured to form a centralized data hub.

In one embodiment, the data interfacing device is configured to form a centralized data hub.

In one embodiment, the data interfacing device is retrofittable to the electrically powered vehicle to replace an original display of the electrically powered vehicle.

In accordance with another aspect, there is provided a data interfacing device for an electrically powered vehicle, comprising: a processor; one or more electrical signal interfaces in communication with the processor, the one or more electrical signal interfaces configured to interface with and receive from a control system of an electrically powered vehicle predefined vehicle data comprising at least one of vehicle battery level and vehicle operational information; one or more operational sensors for detecting any one or both of motion and location of the electrically powered vehicle; a short-range wireless communication interface configured to communicate with, using a short-range, low-power communications protocol, a software-enabled human interface device to provide the predefined vehicle data thereto; and a power source that provides electrical power for continuous operation of the data interfacing device during predefined periods.

In one embodiment, the short-range wireless communications interfaces is further configured to communicate with, using the short-range, low-power communications protocol, one or more external sensor devices, such that any external sensor data is communicable to the software-enabled human interface device via the short-range, low-power communications protocol.

In one embodiment, the short-range wireless communication interface is configured to communicate with, using the short-range, low-power communications protocol, one or more proximate locationally-aware nodes on an existing global mesh network of locationally-aware nodes configured for communicating on the short-range, low-power communications protocol, and further configured to communicate location data to the software-enabled human interface device.

In one embodiment, the one or more electrical signal interfaces comprises: a first electrical signal interface in communication with the processor, the first electrical signal interface interfaceable with the control system of the electrically powered vehicle to receive from the control system predefined vehicle data comprising at least one of the vehicle battery level and the vehicle operational information; and a second electrical signal interface in communication with the processor, the second electrical signal interface interfaceable with a user input device of the electrically powered vehicle and configured to receive from the user input device vehicle input data comprising at least vehicle control commands. In this embodiment, the short-range, low-power communications protocol is configured to wirelessly communicate both the predefined vehicle data and the vehicle input data to the software-enabled human interface device.

In one embodiment, the device is retrofittable to the electrically powered vehicle such that the software-enabled human interface device in communication therewith replaces an original display of the electrically powered vehicle.

In one embodiment, the peripheral user input system comprises a peripheral user input device having a clickable scroll wheel.

In accordance with another aspect, there is provided a method of determining electrically powered vehicle fleet usage insights, comprising the steps of: fitting a data interfacing device to each electrically powered vehicle of fleet of electrically powered vehicles, wherein the data interfacing device comprises: a processor; one or more electrical signal interfaces in communication with the processor, the one or more electrical signal interfaces configured to interface with and receive from a control system of the electrically powered vehicle predefined vehicle data comprising at least one of vehicle battery level and vehicle operational information; one or more operational sensors for detecting any one or both of motion and location of the electrically powered vehicle; a short-range wireless communication interface configured to communicate with, using a short-range, low-power communications protocol, a software-enabled human interface device to provide the predefined vehicle data thereto; and a power source that provides electrical power for continuous operation of the data interfacing device during predefined periods; storing electrically powered vehicle usage data from software-enabled human interface devices associated with the fleet of electrically powered vehicles in a remote data storage; and determining, using a digital data processor executing a set of stored computer-readable instructions, electrically powered vehicle fleet usage insights based on the electrically powered vehicle usage data stored in the remote data storage.

In one embodiment, the vehicle fleet usage insights comprise insights pertaining to carbon emission data or carbon credit data. Various embodiments of steps of the method are described elsewhere herein.

It is to be appreciated the any one or more of the above aspects may be combined, and/or that components and/or features of any one aspect may be combined with those of any one or more other aspects, in various embodiments, without limitation.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a top perspective view of an interface device or adapter for interfacing with an electrically powered vehicle, in accordance with one embodiment;

FIG. 2 is a bottom perspective view of the interface device or adapter shown in FIG. 1;

FIG. 3 is a top view of the interface device or adapter shown in FIGS. 1 and 2;

FIG. 4 is a side view of the interface device or adapter shown in FIGS. 1 to 3, illustrating one embodiment of a connector which is connectable to an input device, such as a button pad, of the electrically powered vehicle for receiving various user commands in use;

FIG. 5 is an end perspective view of the interface device or adapter shown in FIGS. 1 to 4, in part illustrating a connector which is connectable to a controller of the electrically powered vehicle, in accordance with one embodiment;

FIG. 6 is a side end perspective view of the interface device or adapter shown in FIGS. 1 to 5, in part illustrating a light indicator which reflects a battery level or charge of the electrically powered vehicle, in accordance with one embodiment, as well as a wired data exchange and/or power delivery port which can be used to charge a user device, in one embodiment, and/or to relay data thereto;

FIG. 7 is a three-dimensional view of the embodiment of the connector shown in FIG. 4, which is connectable to the input device (e.g., button pad) of the electrically powered vehicle for receiving various user commands in use;

FIG. 8 is a cutaway view of the interface device or adapter shown in FIGS. 1 to 7, illustrating one embodiment of an internal configuration thereof, including the independent power supply (e.g., rechargeable battery);

FIG. 9 is a further cutaway view of the interface device or adapter shown in FIGS. 1 to 8, illustrating one embodiment of the internal configuration thereof, including wiring between various componentry;

FIG. 10 is a top perspective view of an enclosure or housing of the interface device or adapter shown in FIGS. 1 to 9, in accordance with one embodiment;

FIG. 11 is a rendered component diagram illustrating the installation of the interface device or adapter, in accordance with one embodiment;

FIG. 12 is a rendered diagram of a mobile application dashboard or home screen, in accordance with one embodiment, displayed on a user device wirelessly connected to the interface device or adapter;

FIG. 13 is a rendered diagram of a mobile application navigation screen, in accordance with one embodiment, displayed on a user device wirelessly connected to the interface device or adapter;

FIG. 14 is a rendered diagram of a web-based supporting platform, in accordance with one embodiment, displayed on a remote user device connected to the Internet;

FIG. 15 is a flow-diagram of a data interfacing system architecture, in accordance with one embodiment, including the interface device or adaptor disclosed herein;

FIG. 16 is a bottom perspective view of an interface device or adaptor mount, in accordance with one embodiment;

FIG. 17 is a flow-diagram of a data interfacing system architecture, in accordance with one embodiment, wherein the interface device or adaptor employs a Bluetooth™ wireless mesh network to triangulate the location of the interface device or adaptor and/or electrically powered vehicle, such as in security applications;

FIG. 18 is an exploded view of another exemplary interface device or adapter for interfacing with an electrically powered vehicle, in accordance with one embodiment; and

FIG. 19 is a three-dimensional view of an exemplary button pad for connection to an interface device or adaptor, hereby providing alternative user input means, in accordance with another aspect of the disclosure.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references unless the context clearly dictates otherwise. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

Although reference to “e-bike” is made throughout this disclosure, this term is intended to include reference to any electrically powered vehicle (i.e., including electric scooters), and in some embodiments, to human-propelled electrically powered vehicles. Similarly, the term “electrically powered” is to be understood to include partially powered and fully powered vehicles, such that the term is inclusive of pedal assist vehicles, for example.

Reference herein to “e-bike data” includes reference to any one or more of the following, without limitation: e-bike identifier, e-bike user identifier and/or information, e-bike speed, e-bike heading, e-bike location, e-bike route information, e-bike navigation information, e-bike battery level and/or charge status, e-bike error reporting data, e-bike crash report data, e-bike theft report data, or the like. In some embodiments, the e-bike data includes historic data of previous trips or routes, as the context will indicate.

Reference herein to “third-party data” generally refers to external data from external data sources, being external to the device and/or system embodiments disclosed herein. Notwithstanding same, it is to be appreciated that there may be an overlap in data acquired by the device and/or system, and data externally acquired, in some embodiments.

The term “device”, “adaptor” or ‘hub” as used herein is intended to include a similarly configured system, and indeed it is to be appreciated that such device, adaptor, hub or system in some embodiments is employed in related methods for interfacing between electrically powered vehicles and user devices.

In conventional e-bikes, every electrical part of an e-bike is typically connected to the e-bike controller, which sends e-bike data to the original or native e-bike display via Universal Asynchronous Receiver/Transmitter (UART) protocol or the like. The e-bike display also acts as a link between the button pad and the e-bike controller, enabling features such as on/off, increasing or adjusting pedal assist (PAS) and changing e-bike settings.

Embodiments disclosed herein provide a means, device, system and/or method for replacing existing e-bike displays with a software-enabled human interface device, or otherwise supplementing existing displays, or yet otherwise providing a suitable display (e.g., where e-bike does not have existing display or user interface component). For example, some embodiments provide for replacing an e-bike display with a smartphone, tablet computer or similar personal user device. Embodiments disclosed herein provide a means, device, system and/or method for conveying or streaming e-bike data (e.g., battery level, suspension readings, increased/decreased pedal assist, or the like) from an e-bike controller to an alternative software-enabled human interface device via configured software. For example, some embodiments provide for conveying or streaming e-bike data from an e-bike controller to a smartphone via a mobile application (“app”). In some embodiments, the mobile application is configured to enhance user experience and/or simply user interactivity therewith, to promote broad feature usage. For example, a user may find navigating a graphical user interface of a mobile application more familiar and/or manageable to access e-bike features, as opposed to navigating the original or native e-bike display and/or software configuration.

Embodiments disclosed herein provide an interface device or adaptor (or “hub”, or “smart adaptor”) which is retrofittable to an e-bike to replace the original, conventional or native e-bike display. In some embodiments, the interface device or adaptor is directly connectable to the e-bike controller to obtain the e-bike data for processing and/or conveying or streaming to the alternative software-enabled human interface device or personal user device, or in some cases provide control signals to the e-bike controller. Some embodiments provide for direct connection to the e-bike controller via a multi-fit electrical connector which is configured specifically for this purpose. In some embodiments, the multi-fit connector is configured to retrofit the interface device or adaptor to various types of e-bikes (i.e., is connectable to e-bike controllers from various manufacturers, and/or is considered widely compatible). In some embodiments, the multi-fit connector is further configured to maintain electrical connection during motion, including significant shaking and bumping due to irregular e-bike motion; it may be further configured in some embodiments to protect the connection from water, mud, etc., which may contact the exterior of the multi-fit connector because of weather, splash from riding surfaces, or fluids from a rider. In some embodiments, the multi-fit electrical connector comprises a flexible or partially flexible exterior component that encloses and/or grasps the connection to the e-bike controller; such component operates to protect the connection from moisture and seeks to avoid unexpected disconnection.

Embodiments of the interface device or adaptor disclosed herein, as well as related systems and methods, provide for conveying, transmitting or streaming the e-bike data, and optionally further data obtained or processed by the interface device or adaptor itself, to the alternative software-enabled human interface device. In some embodiments, this data transfer from the interface device or adaptor to the user device is provided is wireless format. In some embodiments, short-range low-energy wireless technologies are employed. For example, certain embodiments rely on wireless protocols or standards such as Bluetooth™, Adaptive Network Topology (e.g., ANT+), ultra-wideband (UWB), Near-Field Communication (NFC) or the like, without limitation. Embodiments offering real-time or live transfer are envisaged, such that a user can (near) immediately view e-bike data (and optionally, third-party data) on the user device. Similarly, real-time or live notifications are envisaged.

Embodiments of the interface device or adaptor disclosed herein, as well as related systems and methods, provide a means for accessing or viewing e-bike data and/or processed data from remote locations in the absence of e-bike power supply. For example, if the e-bike is switched off, or the e-bike battery is drained, the interface device or adaptor of some embodiments is still capable of conveying, transmitting or streaming the e-bike data, and optionally further processed data, to the user device. In some embodiments, such features are provided through an independent and optionally rechargeable battery in the interface device or adaptor itself.

Embodiments of the interface device or adaptor disclosed herein, as well as related systems and methods, are configured to employ one or more wireless mesh networks to provide usage in the absence of Internet connection. Various embodiments employ various different protocols and/or schemes for routing packets across the wireless mesh network. In one embodiment, the interface device or adaptor employs a Bluetooth™ wireless mesh network (or Bluetooth Mesh standard), such as that Bluetooth-connected devices are relied upon for low-energy data transfer in the absence of the Internet (or Wireless-Fidelity). In some embodiments, the wireless mesh network is relied upon for select data transfer, such as being limited to location tracking. In other embodiments, the wireless mesh network is relied upon for additional or full data transfer, depending on the application. It is to be appreciated that various wireless mesh networks utilize various encryption methods between devices, such that data transfer of e-bike data (optionally limited to location) is considered secure.

Embodiments of the interface device or adaptor disclosed herein, as well as related systems and methods, provide for connectability to one or more additional hardware devices (e.g., sensors or products), in addition to the e-bike controller. Such one or more additional hardware devices may be manufactured by third parties as distinct devices or otherwise may be employed within the e-bike by the original manufacturer, for example. In some embodiments, additional hardware device(s) are connectable to the interface device or adaptor via a multi-fit electrical connector. In other embodiments, additional hardware device(s) are connectable to the interface device or adaptor via a wireless connection. Notably, these wireless embodiments may provide for a retrofittable device or adaptor that supports Internet-of-Things (IoT) type configuration, although not necessarily over the Internet. For example, in one embodiment, the interface device or adaptor is Adaptive Network Topology (ANT or ANT+) standard or protocol-enabled, such that the interface device or adaptor can wirelessly communicate with additional hardware device(s) which are similarly enabled on demand. This wireless connectivity, when provided, allows additional hardware device(s) to be optionally connectable, such that a user can configure what data is required/desired and/or what data is shared with the device or adaptor. As one non-limiting example, this wireless connectivity supporting IoT configuration is usable to connect or pair the device or adapter with a smart watch (e.g., Garmin™ watch), such that the additional third-party data obtained by the smart watch (e.g., heart rate, pulse, location) is communicated to the device or adaptor. In turn, such embodiments provide for the conveying, transmitting or streaming the additional data from the additional device(s), and optionally further data obtained or processed by the interface device or adaptor itself, to the alternative software-enabled human interface device. In some embodiments, as noted above, data transfer from the interface device or adaptor to the user device is provided in wireless format (e.g., via Bluetooth™ or other formats described herein). It is to be appreciated that such embodiments combine or integrate the e-bike data and any additional (third-party) data into a single stream or data packet or set of data packets. In some embodiments, this combined or integrated data is, in turn, displayed on the user device (i.e., a single interface), such that the user does not require multiple displays or screens on the handlebar (or at least, reduces the number of screens required, or alternatively, reduces the need to also review data or statistics on a smart watch, for example). Indeed, such combination or integration of data from the e-bike and third-party devices may enhance user experience and/or interaction, from purchase and installation to troubleshooting. Furthermore, in some embodiments, there is provided a software program through which the e-bike data and additional data is displayable through a user interface. In some embodiments, additional data is processed for display as widgets.

Embodiments of the interface device or adaptor disclosed herein, as well as related systems and methods, enable inputs from a button pad(s) of a e-bike (or similar input device, without limitation) to be relayed to the e-bike controller, such that continued utility of the button pad(s) is enabled. Some embodiments provide a peripheral user input device which is connectable to the interface device or adaptor, as an alternative to conventional button pads typically provided with e-bikes. Such peripheral user input devices enable user inputs to be relayed to the e-bike controller and/or to software associated with the interface device or adaptor (e.g., such that a user is able to interact with the CYKEL app via the peripheral user input device in some embodiments).

Embodiments of the interface device or adaptor disclosed herein, as well as related systems and methods, provide one or more additional sensors integrated within the interface device or adaptor itself (i.e., onboard sensors). Sensed data from such sensors, when communicated to the CYKEL software or broader system for processing, provide for insight determination into ride performance and/or operational parameters, thereby enhancing overall user experience when included. In various embodiments, the one or more additional sensors include, without limitation, an accelerometer, a gyroscope, a magnetometer, another motion sensor, a (air) temperature sensor, an air pressure tensor, an air quality sensor, an ambient light sensor, a humidity sensor, another environmental sensor, or the like. In one embodiment, the interface device or adaptor is provided with satellite-based navigation capabilities, such as Global Positioning System (GPS) capabilities (e.g., a GPS receiver and/or antenna), which provides location and/or navigation features to the device or adaptor, which is optionally relayed to the user device. In other embodiments, the provision of GPS capabilities within the interface device or adaptor allows for the addition of further technical features. For example, GPS capability in some embodiments is configurable to provide remote access to the device or adaptor, for live telemetry.

Embodiments of the interface device or adaptor disclosed herein, as well as related systems and methods, provide for a simple, damage-resistant and/or tamper-resistant design. In some embodiments, no data (i.e., e-bike data or additional data) is displayed or visible on the interface device or adaptor whatsoever. In other embodiments, the interface device or adaptor is configured to provide one or more visual indicators of select data. For example, in one embodiment, the interface device or adaptor comprises a light-based indicator (e.g., light-emitting diode(s)) which in use displays a battery status or charge level of the e-bike battery (or other data in other embodiments). Notably, such embodiments having one or more visual indicators on the interface device or adaptor are useful in the context of when a user device is not available or paired to the device or adaptor, allowing a user to determine battery status, for example, in the absence of a user device or in the absence of pairing.

Embodiments of the interface device or adaptor disclosed herein, as well as related systems and methods, provide additional safety and/or security features. Some of these embodiments employ wireless mesh network topographies so as to communicate safety and/or security alerts to one or more predefined contacts in the absence of a connected or paired user device. One embodiment provides for crash detection. Another embodiment provides for theft detection. Yet another embodiment provides for device or adaptor locking, optionally by way of Near Field Communication (NFC) locking. One embodiment provides for pollution sensing.

Embodiments of the interface device or adaptor disclosed herein, as well as related systems and methods, provide a durable and robust solution which is simple to install if being retrofit. In some embodiments, the interface device or adaptor (and optionally, its wired connection to the e-bike controller) is configured to be waterproof.

Embodiments disclosed herein provide an interface device or adaptor mount for mounting the interface device or adaptor disclosed herein to an e-bike. In some embodiments, this interface adaptor mount is configured to be retrofittable to an e-bike, regardless of make or model. For example, the interface adaptor mount is configured to be mountable to a handlebar or other frame portion of an e-bike, in some embodiments. In other embodiments, the interface adaptor mount (and/or device or adaptor itself) is configured or customized for a particular e-bike make or model, or indeed a particular handlebar design or other particular frame portion. In yet other embodiments, the interface device or adaptor mount is configured to be integrated within a handlebar or other frame portion of an e-bike during manufacture.

Embodiments of the interface device or adaptor disclosed herein, as well as related systems and methods, combine a plurality of the features disclosed herein, thereby providing a feature-rich adaptor which is more advanced than existing retrofittable display devices or screens, for example. As noted, some embodiments provide for conveying or streaming e-bike data from an e-bike controller to a smartphone via a mobile application (“app”). Further embodiments disclosed herein provide computer-implantable instructions stored on a computer-readable medium which, when executed, allow for the execution of such a mobile application. In one embodiment, the mobile application displays on a user device the data from the interface device or adaptor (i.e., the e-bike data and optionally, additional data from additional sensors or devices). In some embodiments, the instructions comprise instructions which, when executed, allow for the display of third-party data via the same mobile application. For example, the mobile application may integrate e-bike data with courier or delivery data from third-party applications related to courier or delivery services (e.g., Uber™). Such embodiments may be beneficial by ensuring, for example, that a user need not toggle or switch between various running mobile applications during use of the e-bike to see, for example, e-bike data and courier data. Indeed, such embodiments merge or converge this data into a single application programming interface (API), on demand (e.g., simplifying user experience or interaction).

Embodiments of the mobile application software disclosed herein further provide for e-bike diagnostics. Indeed, the interface device or adaptor disclosed herein, as well as related systems and methods, is configured to receive diagnostic reports directly from the e-bike and includes instructions to process such diagnostic reports accordingly.

Embodiments of the mobile application software disclosed herein provide for the generation and/or display of widgets, which in some embodiments is/are depicted on the “live view” dashboard on the right-hand side. One example is shown in FIG. 12, where a widget displays trip data, but it is to be appreciated that the user can change this as desired to other widgets that may be more useful to their ride including: Trip Duration, Odometer, Media Player, Mini Map, Battery Voltage Meter, Clock, Compass, Air Quality, Altimeter and/or the like.

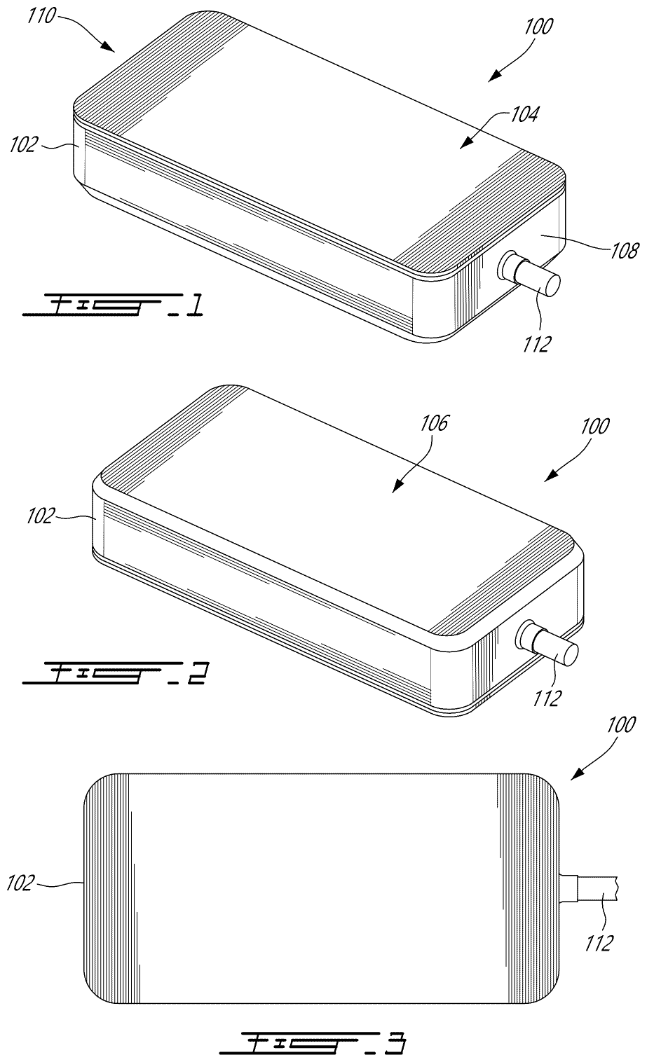

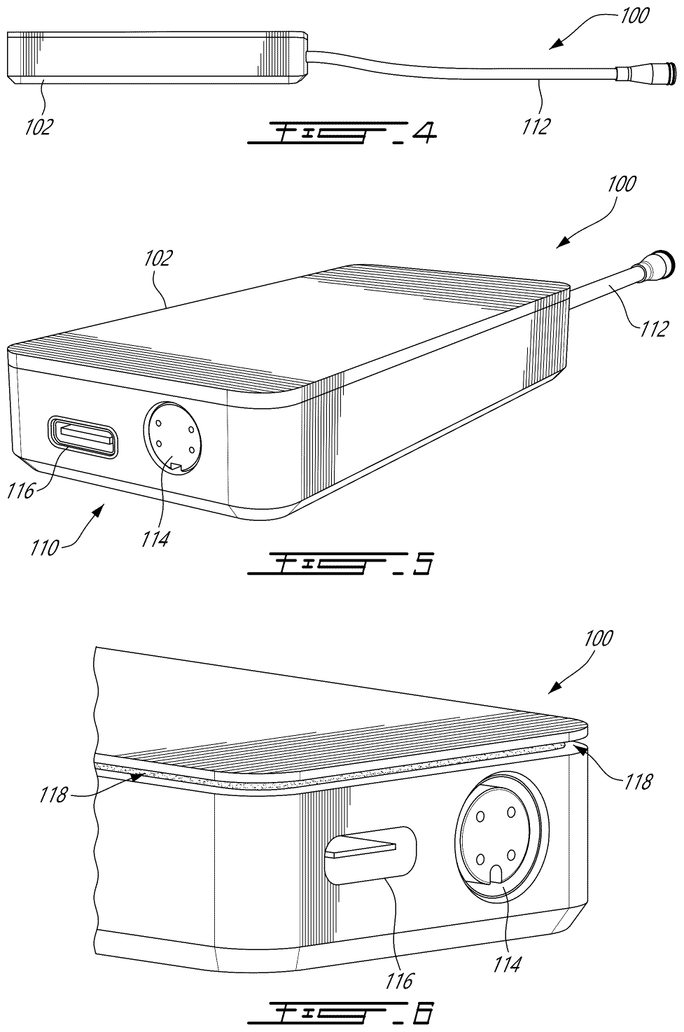

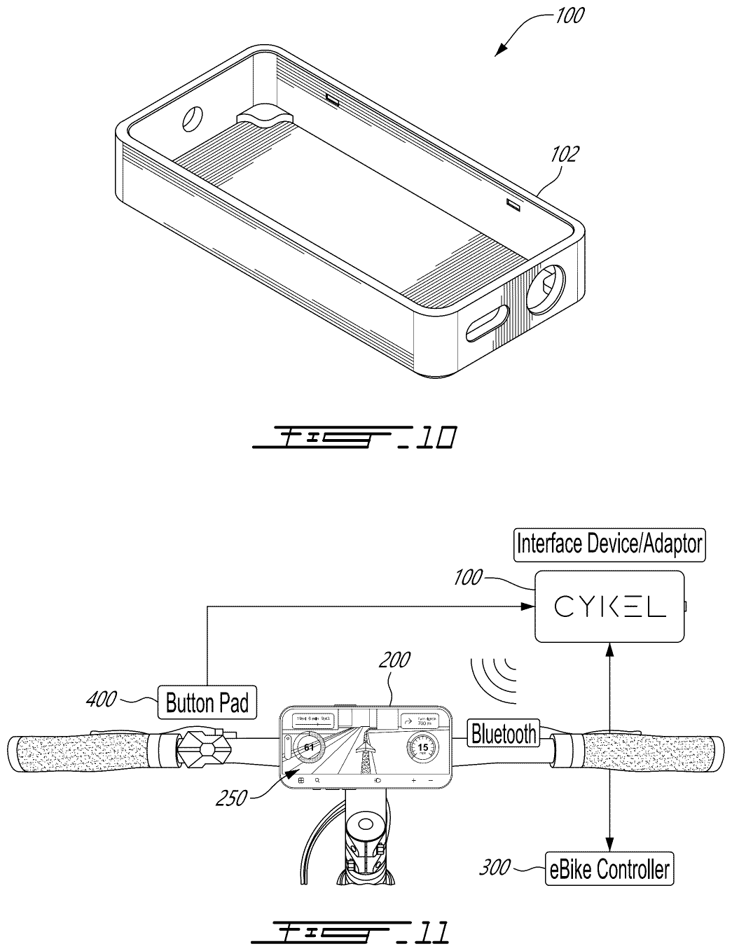

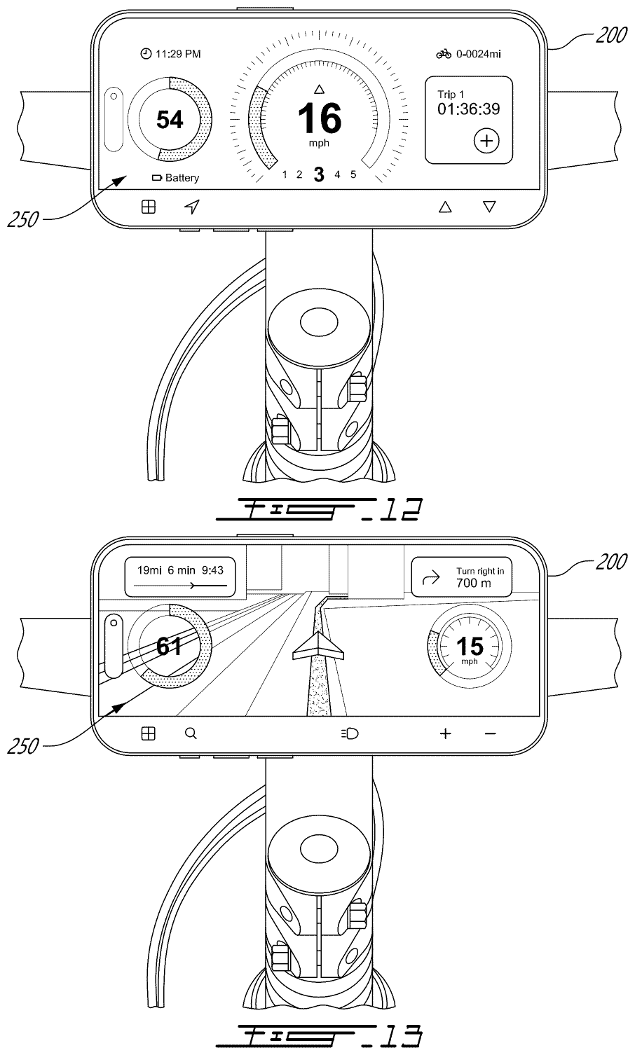

One embodiment of the interface device or adaptor 100 will now be described with reference to FIGS. 1 to 10, without limitation. This embodiment of the interface device 100 includes a robust body 102 having an upper body face 104, a lower body face 106, opposed side faces, and opposed end faces 108, 110. In this embodiment, the interface device 100 includes a single electrical signal interface 112 extending outwards from the body 102 at one end 108, the interface 112 being in communication with the processor of the interface device 100. As noted elsewhere, the electrical signal interface 112 (or “e-bike connector”) is configured to interface with and receive from a control system of the e-bike predefined vehicle data comprising at least one of vehicle battery level and vehicle operational information. As shown in FIG. 7, the electrical signal interface 112 comprises a 5-pin electrical connector in this embodiment, and will be described in further detail below (note other embodiments employ 6 or 7 pins, or any other number as needed).

In this embodiment, as shown in FIGS. 8 and/or 9, the interface device or adaptor 100 includes a processor and memory configured to manage the data flows and/or processing described herein. In this particular embodiment and without limitation, the interface device or adaptor 100 includes a 64 MHz Arm Cortex-M4 with FPU processor, together with 512 KB Flash and 256 KB RAM memory.

In this embodiment, the interface device or adaptor 100 includes a chipset managing data flow between the processor, memory and peripherals. In this embodiment, the chipset comprises a Nordic™ nRF chip set, provided in an FCC pre-certified module option.

In this embodiment, the interface device or adaptor 100 includes a plurality of wireless connectivity options, which enables the wireless connection of various user devices (e.g., smartphone 200, smartwatch, another smart wearable or the like) or third-party devices to the interface device or adaptor 100. More specifically, in this embodiment, the interface device or adaptor 100 supports Bluetooth™ 5.0, ultra-wideband, NFC and ANT+protocols.

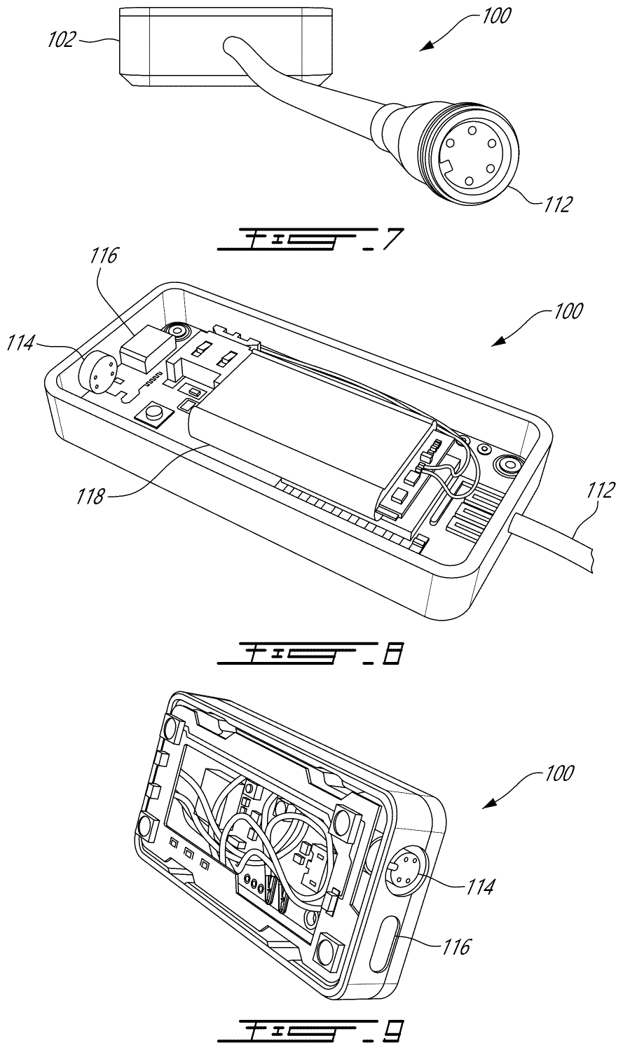

In this embodiment, the interface device or adaptor 100 includes a plurality of wired connectivity options, one of which intended for wired connection to the e-bike controller (that being 112 described above) and one 114 intended for wired connection to the e-bike button pad (see FIGS. 5 and 6). In this embodiment, the former 112 is in the form of a 5-pin Male Higo™ connector and the latter 114 is in the form of a 4-pin Female Higo™ input, optionally provided on opposing ends of the interface device or adaptor 100 as shown in FIGS. 1 to 10. In this embodiment, the 4-pin Female Higo™ input connector 114 is provided with a JST™ termination to the processor. Notably, other e-bike connectors or designs may be employed in other embodiments.

In this embodiment and when connected to an e-bike, the 5-pin Male Higo™ connector 112 of the interface device or adaptor receives a 5-pin Female Higo™ connector from the e-bike controller which, in turn, is connected to the e-bike battery. As such, the primary (although not only) power source of the interface device or adaptor 100 in this embodiment is the e-bike battery itself. In this embodiment, the interface device or adaptor 100 accepts voltages ranges of 24V to 72V.

In this embodiment, the interface device or adaptor 100 includes a wired data exchange and/or power delivery port 116 (optionally provided on one end 110 of the device or adaptor 100) which enables the interface device or adaptor 100 to communicate to an external device data and/or power. In this embodiment, the wired data exchange and/or power delivery port 116 is in the form of a Universal Serial Bus (USB) C female input port, although other embodiments may employ other types. In this embodiment, the USB-C port 116 is water resistant and is provided with a seal (e.g., rubber gasket). The USB-C port 116 in this embodiment allows, for example, a user to wiredly connect their user device (e.g., smartphone 200) to the interface device or adaptor 100 to charge when in use.

In this embodiment, the interface device or adaptor 100 includes a visual indicator 118 (shown in FIG. 6) which in use, reflects a battery level or charge of the e-bike. In this embodiment, the visual indicator 118 is in the form of a light indicator, and specifically a light-emitting diode (LED) strip 118 which wraps around the enclosure or housing 102 of the interface device or adaptor 100. In this embodiment, the LED strip 118 reflects the e-bike battery level or charge on the interface device or adaptor 100 itself, such that a user is able to visualize this information on the interface device or adaptor 100 in the absence of a connected or paired user device (e.g., smartphone). In this embodiment, different colour displays are employed to reflect different e-bike battery charge levels, and optional pulsing colour display is employed to reflect errors or other relevant battery parameters, without limitation.

In this embodiment, the interface device or adaptor 100 includes a plurality of (onboard) sensors, including both motion and environmental sensors. In this embodiment, the motion sensors include a three-axis gyroscope, an accelerometer, an altimeter and a three-axis magnetometer (e.g., ST™ LIS3MDL Digital output 3 Axis magnetometer). In this embodiment, the environmental sensors include sensors for measuring ambient light, air pressure, air temperature (e.g., Sensirion™ SHTC3 Humidity and Temperature Sensor), air quality (e.g., Bosch™ BME680 or a Volatile Organic Compound sensor) and humidity. It is to be appreciated that in some embodiments, any one or more of the above sensors may be excluded from the interface device or adaptor 100, particularly where the user device (e.g., smartphone) incorporates such sensors or such sensing capability. For example, as smartphones develop and include magnetometer functions, this sensor may be omitted from the interface device or adaptor 100 (or optionally disabled depending on the user device capabilities). In one specific embodiment, the interface device or adaptor 100 is provided with only an air quality sensor, a temperature sensor and a light sensor, the remaining sensors considered available on modern smartphones (i.e., barometer, three-axis gyroscope, accelerometer, proximity sensor and ambient light sensor).

In this embodiment, the interface device or adaptor 100 includes an independent power source 118 in the form of a battery (see FIG. 8). In this embodiment, the independent battery of the interface device or adaptor 100 is rechargeable and is specifically configured to be recharged from the battery of the e-bike when in use. When the e-bike is not in use or when the e-bike battery is depleted, for example, the independent battery of the interface device or adaptor 100 allows it to function in the absence of external power. In this embodiment, the independent battery comprises a Lithium-Ion Polymer 3.7V 1000 mAh built-in rechargeable battery, using a 5-Pin Higo Connector 112 for power supply and outputting 18 watts USB C PD Output 116. In some embodiments, the independent power source 118 enables features such as crash and/or theft detection, even when the battery of the e-bike is depleted, for example.

In this embodiment, the body 102 of the interface device or adaptor 100 includes an enclosure or housing which is robust and substantially waterproof (or at least, water resistant to withstand weather exposure). In this embodiment, the enclosure 102 has a lid which enables access to the interior of the enclosure, such as for repairs or maintenance (e.g., battery replacement). In this embodiment, the lid connects to the enclosure by means of clips, studs or similar interlocking members. In one embodiment, a plurality of clips on the lid securely engage a continuous slot along an interior surface of the enclosure. In this embodiment, the interface device or adaptor 100 includes a seal (e.g., O-ring) between the enclosure body and the lid. The lid in this embodiment is injection moulded, although various other manufacturing techniques may be useful.

In this embodiment, the enclosure 102 of the interface device or adaptor 100 has dimensions of approximately 74 mm by 36 mm by 15 mm. As shown in FIGS. 1, 2 and 5 for example, the enclosure 102 includes beveled or chamfer edges of approximately 0.25 mm. In this embodiment, the enclosure 102 is manufactured or machined of aluminum, and optionally includes an anodized dark grey finish. In this embodiment, the interface device or adaptor 100 is lightweight, weighing approximately 73 grams. In some embodiments, the enclosure 102 or a portion thereof may be filled or encapsulated with a potting or epoxy compound so as to further improve waterproofing of the interface device or adaptor. In one embodiment, the processor is encapsulated in resin. In one embodiment, the 4-pin Female Higo™ input connector 114 is inserted into an aperture of the enclosure 102, facing one end 110 thereof, and epoxy is poured into a slot to create a waterproof dam around it, whilst also securely holding the connector 114 within the enclosure.

In this embodiment, the interface device or adaptor 100 is operable in various modes, including without limitation: boxed mode (e.g., mode during storage and shipping to customer), first pair mode (e.g., allows user to pair user device (e.g., smartphone 200) and e-bike with the interface device or adaptor), tether-less mode (e.g., unable to pair with mobile application on smartphone 200, interface device or adaptor 100 communicates with e-bike without any mobile application input), tethered mode (e.g., paired with e-bike and mobile application on smartphone 200, streams data to mobile application, this is the ‘normal’ mode), lockout mode (e.g., unable to authenticate the user, disables all e-bike functionality) or sleep mode (e.g., user device 200 and e-bike inactive, waiting for wake up).

In one embodiment, although not specifically shown, the processor of the interface device or adaptor 100 is operable to detect or determine rapid deceleration of the e-bike (and/or other abnormal motions or movements) from any of the data received, or any combination of data. For example, rapid deceleration may be detected based on data originating from: one or more sensors forming part of the interface device or adaptor 100 itself, one or more sensors forming part of the user device (e.g., smartphone 200), one or more sensors forming part of external devices (e.g., smartwatch or mounted GPS system), and/or communication with one or more proximate locationally-aware nodes in a global mesh network (detail on this aspect below). In one embodiment, the processor is configured to communicate a crash alert upon the rapid deceleration detected exceeding a deceleration safety threshold; alternatively, a crash may be detected by assessing whether the time between the e-bike being in motion and the e-bike being stationary or near-stationary is below a threshold, or a combination of the foregoing. In some embodiments, the crash alert is communicated (directly) to predetermined contact information. In additional or alternative embodiments, the crash alert is communicated (indirectly) via one or more proximate locationally-aware nodes on a global mesh network to the predetermined contact information. The latter may be useful, for example, where direct communication (e.g., via the Internet) is not possible or where, for example, the user device is not paired or connected to the interface device or adaptor 100. In some embodiments, the crash alert comprises the location data of the e-bike.

In one embodiment, although not specifically shown, the processor of the interface device or adaptor 100 is operable to detect motion when the interface device or adaptor is not in communication range with the user device (e.g., smartphone). In various embodiments, such motion is detected based on data originating from: one or more sensors forming part of the interface device or adaptor 100 itself, one or more sensors forming part of external devices (e.g., smartwatch, e-bike mounted GPS system or other third-party devices on e-bike), and/or communication with one or more proximate locationally-aware nodes in a global mesh network (again, detail on this aspect below). In one embodiment, the processor is configured to communicate a theft alert upon the motion outside the communication range with the user device (e.g., smartphone 200) being detected as exceeding a predetermined radial threshold. In some embodiments, the theft alert is communicated by/to any one or combination of: (directly) to predetermined contact information, (directly) to the user device (e.g., smartphone), and/or (indirectly) via one or more proximate locationally-aware nodes on an existing global mesh network to the predetermined contact information and/or the user device 200. In some embodiments, the theft alert comprises the location data of the e-bike.

In one embodiment, although not specifically shown, the processor of the interface device or adaptor 100 is operable to communicate a maintenance alert based on data originating from at least one or a combination of: one or more sensors forming part of the interface device or adaptor 100 itself, one or more sensors forming part of the user device (e.g., smartphone 200), one or more sensors forming part of external devices (e.g., smartwatch, e-bike mounted GPS system or other third-party devices on e-bike), and/or communication with one or more proximate locationally-aware nodes in a global mesh network (again, detail on this aspect below). In some embodiments, the maintenance alert is based on at least one of: an amount of time the e-bike is in operation, an amount of time the e-bike is not in motion, an amount of time since a prior maintenance event, a theft alert, a crash alert, vehicle power status (or vehicle battery level), and vehicle operational information. For example, if sufficient total time and/or ride time, possibly as adjusted based on levels of change of acceleration and/or altitude or the occurrence of a theft or a crash, has passed since brake pads have been changed, mechanical components have lubricated, or maintenance assessments have been undertaken, a maintenance alert will be generated by the interface device 100 and transmitted to the user device. In some embodiments, the user may be presented via the user device 200 further data on third-party sources for such materials and/or services, including based on price, availability, and/or proximity. In one particular embodiment, the processor of the interface device or adaptor 100 generates a safety notification to alert the user to if the brake pads and/or tires of the e-bike need replacing, based on trip and usage data (notably, typically based on computer-implementable instructions for same, i.e. an algorithm). It is to be appreciated that conventionally, there are no sensors that can directly tell the user to do this. Similarly, there is also conventionally no way to determine lubrication of parts, only when an e-bike should be serviced based on usage. Additionally, tire pressure cannot be checked without additional sensors or checking pressure manually through a tire pressure gauge. As such, in some embodiments, the processor of the interface device or adaptor 100 comprises instructions which based on data received, generates a safety notification to notify users of any one or more of the forementioned safety concerns which are not typically readily known or available to users.

The embodiment shown in FIGS. 1 to 10 includes a single cable or connector 112 which extends from the interface device or adaptor 100, for connectivity to the e-bike controller, as described, having connector input 114 for optionally receiving further input from the button pad or similar of the e-bike. In another embodiment of the interface device or adaptor 100, which is not shown, the interface device or adaptor 100 comprises two cables or connectors which extend outwards from the device or adaptor 100 (optionally provided on one end 108) for connectivity to the e-bike and/or componentry associated therewith. In one embodiment, the interface device or adaptor 100 comprises a first cable or connector for connectivity to the e-bike controller (i.e., thereby providing an interface for e-bike control and/or monitoring) and a second cable or connector for connectivity to a button pad or similar user input device. In such embodiments, the second cable or connector replaces connector input 114, for example. In some embodiments, the button pad is an existing button pad of the e-bike, for example, whereas in other embodiments a unique button pad or user input device 700 is provided, in accordance with another aspect of the instant disclosure and described elsewhere herein. Notably, provision for connectivity of the interface device or adaptor 100 with one or more external peripherals, devices or components, such as the button pad, further promotes the versatility thereof.

In FIG. 18, another embodiment of the interface device or adaptor 100 is shown. This figure specifically shows an exemplary embodiment of the placement of componentry within the device or adaptor 100, particularly with reference to the processor.

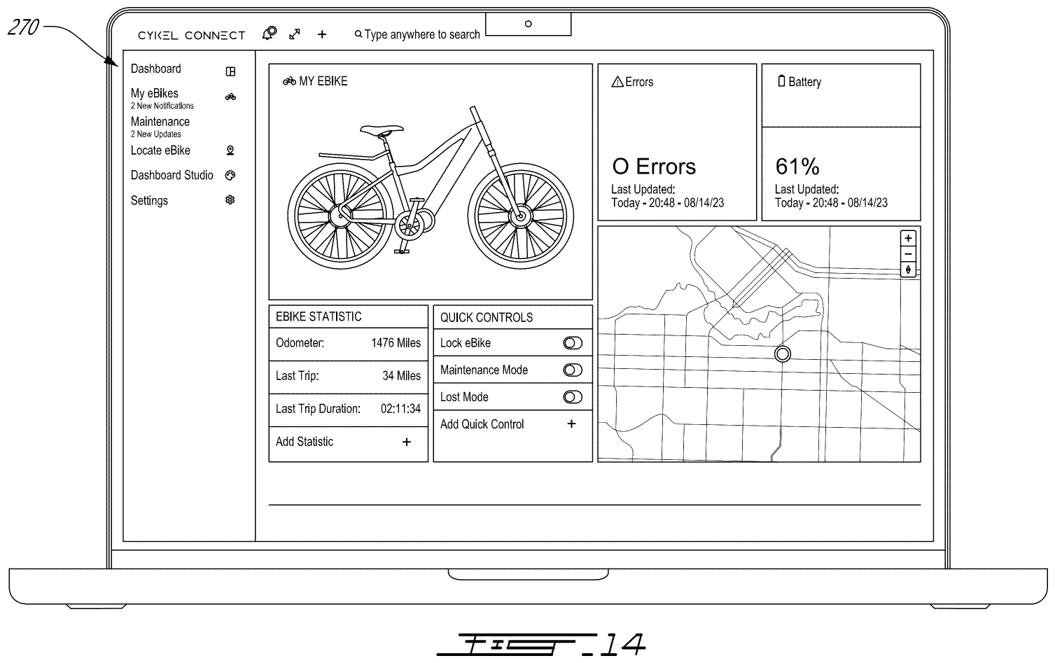

In one embodiment, as shown in FIG. 11 by way of component diagram, in order to install the interface device or adaptor 100, the original or native e-bike display is disconnected from the e-bike controller (optionally, any cables between native e-bike display and button pad(s) are also disconnected), the interface device or adaptor 100 is connected to the e-bike controller 300 via the connector described herein (and optionally, further connected to the button pad(s) 400), and the user device 200 is paired or connected with the interface device or adaptor 100 (e.g., machine-readable code such as QR code provided is scanned with camera on user device 200, user downloads mobile application disclosed herein, follows onscreen instructions to install app and pair user device 200 with interface device or adaptor 100 via wireless technology).

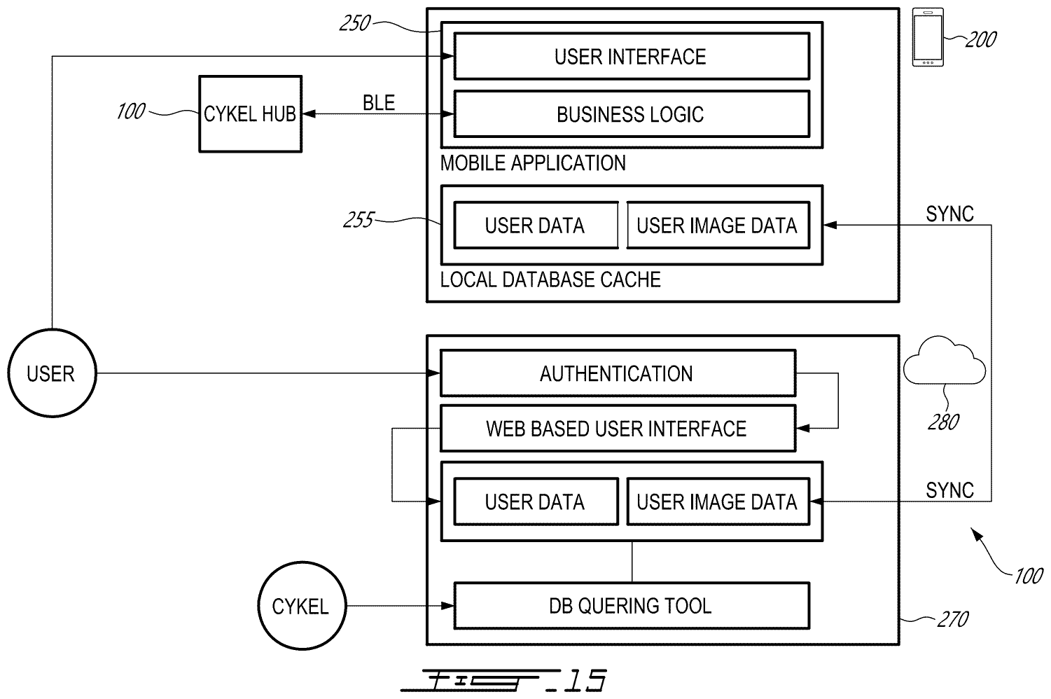

Various embodiments of the mobile application 250 (“CYKEL app”) for execution on a user device 200 are envisaged, and example of different displays within the app 250 are shown in FIGS. 12 and 13.

In one embodiment, the mobile application (“CYKEL app”) 250 for execution on a user device 200 combines or integrates e-bike data and third-party data from third-party devices, software and/or mobile applications (or APIs). In this embodiment, the interface device or adaptor 100 is considered a hub which centralizes all connected hardware (from the e-bike and third-party hardware), and similarly, the mobile application 250 provided combines or integrated all hardware data outputs received into a single platform.

In FIGS. 11 to 13, the user device 100 is executing an exemplary mobile application 250 in use. As shown, the mobile application 250 provides a user-friendly graphical interface in which various data and/or interaction buttons are displayed. FIG. 12 specifically shows an exemplary mobile application dashboard or home screen. In this embodiment, as shown and in no particular order, the dashboard displays: a speedometer with compass and assist indicator, trip or odometer data, a widget (e.g., with third party data), widget selector buttons (e.g., for toggling between various widgets), warning indicators (shown in non-illuminated state), navigation button(s), ride mode toggle button (e.g., to switch to navigation screen), battery percentage, and user data (e.g., profile, time, etc.). FIG. 13 specifically shows an exemplary mobile application navigation screen. In this embodiment, as shown and in no particular order, the navigation screen displays: a three-or two-dimensional map, direction prompts, a speedometer, map zoom buttons, warning indicators, a search button, a ride mode toggle button (e.g., to switch to dashboard), battery percentage and ride data (e.g., duration in minutes, miles or the like). In this embodiment, the mobile application 250 disclosed thus includes a navigational suite, such as the Mapbox™ API, and can track the e-bike location and telemetry in real time. It is to be appreciated that variations in data and/or interaction buttons displayed or available are expected across different embodiments.

In other embodiments, other parameters or settings may be viewed or adjusted, including but not limited to speed, range, pedal assist, settings, error message, other indicators (lights, engine warning) or the like.

In FIG. 14, an exemplary supporting platform 270 is shown (“CYKEL Connect”). In this embodiment, the supporting platform 270 is a cloud-based platform or user-interface which provides all data available through the mobile application 250 (e.g., diagnostic reports, location, telemetry), and optionally additional tools and/or features (e.g., customer service tickets). The supporting platform 270 connects to the interface device or adaptor 100 disclosed herein wirelessly, typically when the mobile application 250 is being used, or otherwise locally via a wireless protocol such as Bluetooth™.

In one embodiment, the mobile application 250 and/or supporting platform 270 supports users (i.e., riders) and e-bike businesses (e.g., ride-sharing businesses). In some embodiments, the mobile application 250 and/or supporting platform 270 is configurable for user or business preferences and/or branding. In one embodiment, the mobile application 250 and/or supporting platform 270 are configurable for fleet management.

In one embodiment, the mobile application 250, supporting platform 270 and/or related system is configured to determine ride intelligence from data collected from the interface device or adaptor 100 (i.e., onboard sensors), and/or the mobile device 200 (and app 250) associated therewith, during use. In particular, in some embodiments, data from any one or combination of the aforementioned sources is collected and stored in some embodiments in a remote data storage (e.g., cloud-based m storage 280). This data is optionally ingested into one or more data structures (not shown) which may, for example, be associated with a particular fleet. For example, ride data from one or more users (e.g., delivery riders) may be collectively stored in a data structure associated with a predefined fleet (e.g., all delivery riders associated with company “A”). In some embodiments, there is provided a set of computer-readable instructions which, when executed by one or more processors, provide an e-bike usage analysis algorithm. The e-bike usage analysis algorithm is configured to analyze e-bike usage differently in various embodiments. For example, some embodiments may analyze e-bike ride performance, e-bike operation performance, or the like. Some targeted embodiments analyze e-bike fleet performance. In some embodiments, such analyses allow for calculating critical metrics based on real-time location tracking and sensor outputs, where such metrics are used to provide validated, data-driven ride insights.

One embodiment of the e-bike usage analysis algorithm is configured to assess, for a predefined fleet, carbon usage data. In particular, sensor data and/or location data associated with all e-bike (or users or rides) designated to be part of the predefined fleet is directed for storage in a single data structure, for further analysis. In turn, e-bike fleet data stored can be run through the e-bike usage analysis algorithm (or the like) to determine carbon usage as compared to, a prior fleet status (e.g., where the fleet went from 10% e-bike deliveries to 20% e-bike deliveries; or where the fleet went from no e-bike deliveries to 50% e-bike deliveries) or as compared to a baseline fleet status (e.g., no e-bikes and all deliveries via high greenhouse gas emitting delivery minivans). Indeed, embodiments envisaged are intended for application in assessing carbon offset credits, for example, by providing reliable (optionally validated) and data-driven insights on e-bike usage.

One embodiment provides for a method of determining carbon credit for a fleet of e-bikes, generally comprising the steps of: retrofitting a fleet of e-bikes with the interface device or adaptor disclosed herein (each e-bike being retrofitted with such interface adaptor); recording at least location usage data associated with fleet of e-bikes for a predefined period (e.g., one quarter or one year), the location usage data being stored in a fleet-based data structure, and determining via one or processors implementing computer-readable instructions, a carbon credit associated with the location usage data for the predefined period, wherein such carbon credit determination is based at least partly on a baseline fleet status. In some embodiments, the baseline-fleet status is an agnostic fleet status (e.g., not fleet specific) whereas in other embodiments the baseline fleet status is a fleet-specific prior fleet status (e.g., for previous predefined periods for that fleet) or a platform-specific prior fleet status (e.g., for a particular use case, such as food deliveries, or ride sharing).

Determining the carbon credit in various embodiments may include, for example, quantifying the usage of the fleet of e-bikes and based on an emission factor of the e-bikes, determining total carbon emissions for comparison to the baseline fleet status. In turn, determining the carbon credit in various embodiments may include, for example, subtracting the total carbon emissions for the predefined period from the baseline fleet status, to arrive at the carbon credit. In some embodiments, since the carbon credit determination is based at least in part on location usage data, obtained from one or more sensors associated with the interface device or adaptor disclosed herein, such carbon credit determination is considered valid and indeed, verifiable. Thus, the method of determining carbon credit for a fleet of e-bikes may, in some embodiments, provide e-bike fleet companies with a verifiable mechanism for determining carbon offset, thereby enhancing business operations and environmental sustainability.

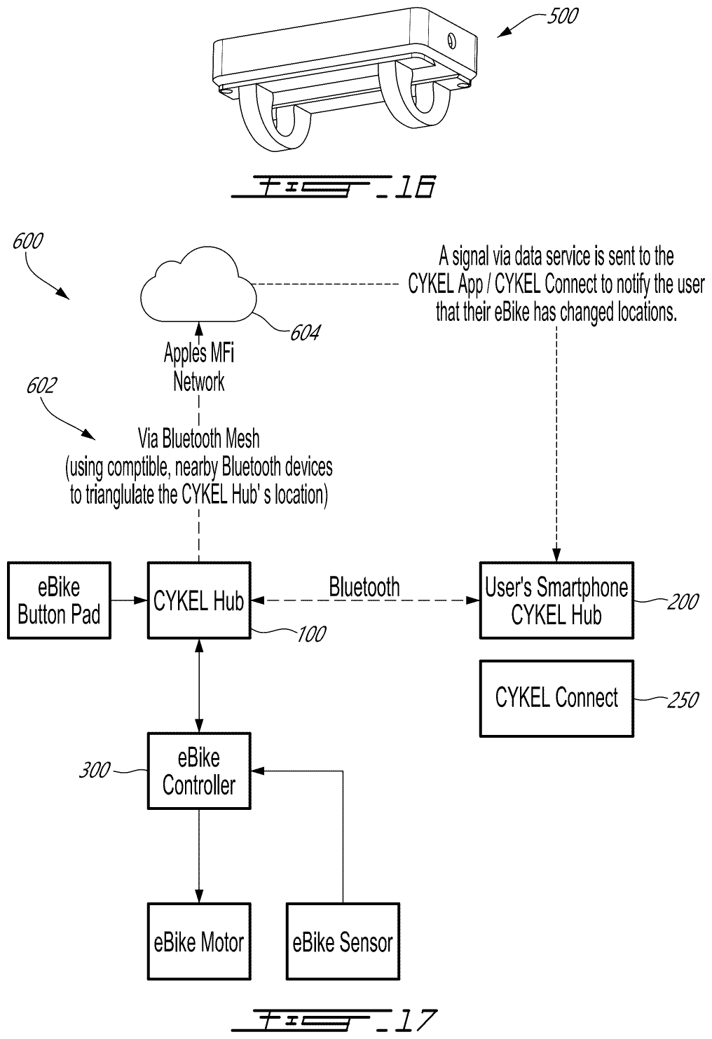

FIG. 15 provides an exemplary system architecture from one embodiment of a system including an embodiment of the interface device or adaptor 100 disclosed herein. As shown, the user can interact with the mobile application 250 via a mobile user device 200 (e.g., smartphone) and/or can interact with the cloud-based support platform 270 via a remote device. The interface device or adaptor 100 is wirelessly connected to the mobile user device 200 in this embodiment via Bluetooth™ (Bluetooth™ Low Energy or BLE) and provides to the mobile user device 200 the e-bike data (and optionally, any third-party data or data determined by the adaptor 100 itself). By creating a local database cache 255 on the mobile user device 200, various logic is able to display this data to the user via the (graphical) user interface. In turn, this local database cache 255 from the mobile application 250 is synced to the cloud database 280 of the cloud-based support platform 270, allowing the user to access this data via the web-based user interface (optionally with authentication steps). As such, various ride and/or associated data or statistics is accessible via database querying tools, and optionally is anonymized for privacy reasons. Notably, syncing between the local database cache 255 and cloud database 280 is two-way in this embodiment, such that settings can be adjusted, data viewed, or the like, from either end, both in (near) real or live time.

In FIG. 16, an exemplary interface device or adaptor mount 500 for mounting an exemplary interface device or adaptor 100 disclosed herein to an e-bike is shown. In this embodiment, the mount 500 also serves as a security feature, preventing theft of the interface device or adaptor 100. In this embodiment, the mount 500 is manufactured of silicon. In some embodiments, the interface device or adaptor mount 500 is configured as a clamp, optionally mountable to a handlebar of an e-bike or to a bundle of wires running from a handlebar. In other embodiments, other mount structures, configurations and/or devices may be employed. In one alternative embodiment, the interface device or adaptor mount 500 is in the form of a hot shoe mount.

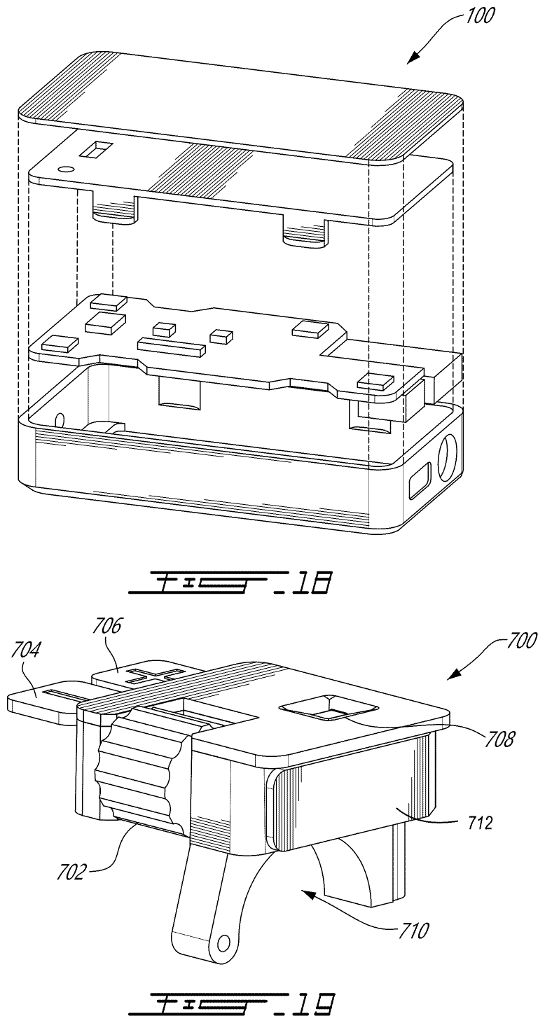

In FIG. 17, a flow diagram of an exemplary Bluetooth™ Mesh data map 600 is shown, in accordance with one aspect of the disclosure. In this embodiment, the interface device or adaptor 100 (“CYKEL Hub”) employs a Bluetooth™ wireless mesh network 602 based on compatible, nearby or proximate Bluetooth-connected devices (which may be referred to as “nodes” in the mesh network) to triangulate the location of the interface device or adaptor 100 (and as such, the e-bike). In this embodiment, the Bluetooth™ wireless mesh network 602 relied upon is the Apple™ MFi Network 604 (or Find My Network, as used by Apple™ AirTags™), although it is to be appreciated that others may be equally workable in other embodiments. If, for example, it is detected based on the location triangulation that the interface device or adaptor 100 (and as such, the e-bike) has changed locations independently of the user device 200, a signal is sent via data services to the mobile application 250 on the user device 200 (and/or the support platform 270 accessible via the web-based interface) to notify the user of the change of location. Furthermore, the notification may include the current location of the interface device or adaptor (and as such, the e-bike). In some embodiments, location assessment using proximate locationally-aware nodes in an existing mesh network 602, 604 can be used to detect the location of the interface device or adaptor 100 (and thus, the e-bike); further, it can also be used to detect motion and/or rate of motion. In cases where motion and/or rate of motion are assessed, this information be used to send crash alerts, theft alerts, updated location information, and other location and/or movement-related data to the user device 200 (and/or the support platform 270 accessible via the web-based interface).

As noted elsewhere herein, the device, system and/or methods disclosed herein may be equally usable or workable with electric scooters. It is to be appreciated that some electric scooters use a smaller (in physical size and/or in voltage) controller, as compared to most e-bikes. As such, suitable modifications are employed for devices, systems and/or methods intended for usage with electric scooters. In one embodiment, the same UART protocol and/or the same 5-pin Higo™ connector are employed. In other embodiments, different protocols and/or connectors are employed. In one embodiment, one or more modifications for the electric scooter button pad/accelerator are employed.

Turning now to FIG. 19, where an exemplary peripheral user input device 700, in accordance with another aspect of the disclosure, is illustrated. The provision of a peripheral user input device 700, in some embodiments, enables user input to the interface device or adaptor 100 (and/or e-bike controller 300 itself). Notably, the peripheral user input device 700 in FIG. 19 may replace an existing e-bike button pad 400 or related input device, or otherwise may provide such a user input means for entry-level e-bikes devoid of such features. In this embodiment, the peripheral user input device 700 is in the form of a “button pad” and is connectable to the interface device or adaptor 100 via a cable connector (not shown). In this embodiment, the button pad 700 includes a scroll wheel 702 which is operable to move in a forward direction and in a reverse direction with respective user engagement, thereby to generate directional signals which are relayed to the interface device or adaptor 100 via the cable connection, in this embodiment. In this particular embodiment, the scroll wheel 702 is configured to generate a plurality of dynamic signals, including related to scrolling and zooming in/out, without limitation. Indeed, the inputs received from the scroll wheel 702 are dynamic based on an active display on the application programming interface (i.e., the app 250 running on the user's connected mobile device 200). For example, the scroll wheel 702 is operable in different embodiments to allow a user to: scroll through e-bike information on a dashboard (e.g., including operational parameters), navigate through various menu items (e.g., including display options or widget options) and/or zoom in and/or out on mapping and/or routing features (e.g., on a navigation display).

The peripheral user input device 700, or button pad in the embodiment of FIG. 19, also provides for click input. In this embodiment, the scroll wheel 702 itself is clickable, such that a user can send input signals to the interface device or adaptor 100 (and/or e-bike controller 300) via clicks on the scroll wheel 702 (i.e., pressing down or engaging the scroll wheel). As such, the button pad 700 enables a user to further engage with or provide input to the application programming interface 250. For example, after scrolling through a menu of options, the user may select one option by pressing the scroll wheel 702 of the button pad 700. In another example, after zooming in or out on a mapping display, the use may select a particular location for the backend to determine routing options thereto.

The embodiment of FIG. 19, and/or other embodiments of the peripheral user input device 700 envisaged, also provides for click input via a separate quick-action input button(s) 712. The quick-action input button(s) 712, located to one side of the peripheral user input device 700, provides for programmable control of the e-bike and/or the associated software described herein. In various embodiments, the quick-action input button(s) 712 is programmable via the user interface (of the “CYKEL app” 250) for predefined functions or actions which are user set. For example, the quick-action input button 712 may activate quick settings, features or actions, optionally with a single click. For example, the quick-action input button 712 may be assigned to an eco-mode by the user, such that a single click thereof commences operation of the e-bike in eco-mode. Or otherwise, the quick-action input button may be assigned to a mapping display (or another widget) such that a single click thereof launches the mapping display on the user's connected device.

In this embodiment, the peripheral user input device also includes one or more features or buttons 704, 706, 708 conventionally associated with such devices on e-bikes. For example, standard control features such as increasing pedal assist 706, decreasing pedal assist 704, power on/off 708, and/or the like, are provided by buttons on the peripheral user input device 700. Notably, the provision of such features in the peripheral user input device 700 disclosed allows it, in some embodiments, to replace standard or off-the-shelf peripheral user input devices 300 with the instantly disclosed one, whilst offering at least some of the additional user interactivity, functionality, versatility and/or efficiency features disclosed above.

The peripheral user input device 700 in this embodiment includes a peripheral user input device mounting feature 710 for mounting it to the e-bike, optionally to a handlebar. As shown in FIG. 19, the scroll wheel 702 is provided on the peripheral user input device 700 within the body of the peripheral user input device 700, at a rearwards-facing side thereof, such that when the peripheral user input device 700 is mounted to an e-bike, such as on a handlebar, the scroll wheel 702 is at a position suitable for a user to engage the scroll wheel with their thumb, without lifting their palm and/or fingers. The quick-action input button(s) 712 and buttons 704, 706 associated with standard controls are similarly positioned to promote user interaction with the peripheral user input device 700 during a ride.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, workpiece, and fabrication material detail may be made, without departing from the spirit and scope of the present disclosure, as set forth in the appended claims, as may be apparent to those of ordinary skill in the art, are also encompassed by the disclosure.

What is claimed is:

1. A data interfacing system for electrically powered vehicles, comprising:
a processor;
one or more electrical signal interfaces in communication with said processor, said one or more electrical signal interfaces interfaceable with a control system of an electrically powered vehicle and configured to receive from said control system vehicle data comprising at least one of vehicle battery level and vehicle operational information;
one or more operational sensors for detecting motion and/or location of said electrically powered vehicle;
one or more short-range wireless communication interfaces in communication with said processor and configured to communicate with, using a short-range, low-power communications protocol:
a software-enabled human interface device; and
one or more proximate locationally-aware nodes on an existing global mesh network of locationally-aware nodes configured for communication using said short-range, low-power communications protocol, said one or more proximate locationally-aware nodes further configured to communicate location data of said electrically-powered vehicle to the software-enabled human interface device; and
a power source that provides electrical power for continuous operation of the data interfacing system.

2. The data interfacing system of claim 1, wherein said one or more electrical signal interfaces comprises an electrical connector connectable to a corresponding connector of said control system.

3. The data interfacing system of claim 2, wherein said electrical connector is in the form of a four-or five-pin connector which is connectable to a plurality of distinctly manufactured control systems.

4. The data interfacing system of claim 1, wherein said one or more electrical signal interfaces comprises an operational input connector connectable to a corresponding operational connector of an operational input device of said electrically powered vehicle.

5. The data interfacing system of claim 1, wherein said processor is configured to receive via said one or more short-range wireless communication interfaces external sensor data from an external sensor device.

6. The data interfacing system of claim 5, wherein said processor is configured to communicate both said vehicle data and said external sensor data to said software-enabled human interface device for concurrent display.

7. The data interfacing system of claim 1, wherein said software-enabled human interface device forms a centralized data hub which replaces an original display of said electrically powered vehicle.

8. The data interfacing system of claim 1, further comprising a visual indicator connected to said processor and configured to visually indicate said vehicle battery level of said electrically powered vehicle independent of said software-enabled human interface device.

9. The data interfacing system of claim 1, wherein said software-enabled human interface device comprises at least one of: a data communication interface, one or more sensor components, a visual display, and a touch screen data input component.

10. The data interfacing system of claim 1, wherein said continuous operation of the data interfacing system includes any one or combination of:
during periods of non-use of said electrically powered vehicle;
during periods when said electrically powered vehicle has a depleted battery; and/or
during periods when said software-enabled human interface device is not proximate said electrically powered vehicle.

11. The data interfacing system of claim 1, wherein said software-enabled human interface device is configured to execute one or more pre-existing software components utilizing data from at least one of: said control system, said one or more operational sensors, one or more external sensor devices, and a peripheral user input device.

12. The data interfacing system of claim 1, wherein rapid deceleration is detected by at least one of: said one or more operational sensors, one or more sensors forming part of said software-enabled human interface device, one or more sensors forming part of or associated with said electrically powered vehicle, and said communication with said one or more proximate locationally-aware nodes; wherein said processor is configured to communicate a crash alert upon said rapid deceleration exceeding a deceleration safety threshold; and wherein said crash alert is communicated via said one or more proximate locationally-aware nodes on said existing global mesh network to predetermined contact information.

13. The data interfacing system of claim 1, wherein to detect motion when the data interfacing system is not in communication range with said software-enabled human interface device, said motion is detected by at least one of: said one or more operational sensors, one or more sensors forming part of or associated with said electrically powered vehicle, and said communication with said one or more proximate locationally-aware nodes.

14. The data interfacing system of claim 13, wherein said processor is configured to communicate a theft alert upon said motion outside said communication range with said software-enabled human interface device being detected as exceeding a predetermined radial threshold; and wherein said theft alert is communicated via said one or more proximate locationally-aware nodes on said existing global mesh network to predetermined contact information.

15. A data interfacing device for an electrically powered vehicle, comprising:
a processor;
one or more electrical signal interfaces in communication with said processor, said one or more electrical signal interfaces configured to interface with and receive from a control system of an electrically powered vehicle predefined vehicle data comprising at least one of vehicle battery level and vehicle operational information;
one or more operational sensors for detecting any one or both of motion and location of the electrically powered vehicle;
a short-range wireless communication interface configured to communicate with, using a short-range, low-power communications protocol, a software-enabled human interface device to provide said predefined vehicle data thereto; and
a power source that provides electrical power for continuous operation of the data interfacing device during predefined periods.

16. The device of claim 15, wherein said short-range wireless communications interfaces is further configured to communicate with, using the short-range, low-power communications protocol, one or more external sensor devices, such that any external sensor data is communicable to said software-enabled human interface device via said short-range, low-power communications protocol.

17. The device of claim 15, wherein said short-range wireless communication interface is configured to communicate with, using said short-range, low-power communications protocol, one or more proximate locationally-aware nodes on an existing global mesh network of locationally-aware nodes configured for communicating on said short-range, low-power communications protocol, and further configured to communicate location data to said software-enabled human interface device.

18. The device of claim 15, wherein said one or more electrical signal interfaces comprises:
a first electrical signal interface in communication with said processor, said first electrical signal interface interfaceable with said control system of the electrically powered vehicle to receive from said control system predefined vehicle data comprising at least one of said vehicle battery level and said vehicle operational information; and
a second electrical signal interface in communication with said processor, said second electrical signal interface interfaceable with a peripheral user input device of the electrically powered vehicle and configured to receive from said peripheral user input device vehicle input data comprising at least vehicle control commands;
wherein said short-range, low-power communications protocol is configured to wirelessly communicate both said predefined vehicle data and said vehicle input data to said software-enabled human interface device.

19. The device of claim 15, being retrofittable to the electrically powered vehicle such that the software-enabled human interface device in communication therewith replaces an original display of said electrically powered vehicle.

20. A method of determining electrically powered vehicle fleet usage insights, comprising the steps of:
fitting a data interfacing device to each electrically powered vehicle of fleet of electrically powered vehicles, wherein said data interfacing device comprises:
a processor;
one or more electrical signal interfaces in communication with said processor, said one or more electrical signal interfaces configured to interface with and receive from a control system of said electrically powered vehicle predefined vehicle data comprising at least one of vehicle battery level and vehicle operational information;
one or more operational sensors for detecting any one or both of motion and location of said electrically powered vehicle;
a short-range wireless communication interface configured to communicate with, using a short-range, low-power communications protocol, a software-enabled human interface device to provide said predefined vehicle data thereto; and
a power source that provides electrical power for continuous operation of said data interfacing device during predefined periods;
storing electrically powered vehicle usage data from software-enabled human interface devices associated with said fleet of electrically powered vehicles in a remote data storage; and
determining, using a digital data processor executing a set of stored computer-readable instructions, electrically powered vehicle fleet usage insights based on said electrically powered vehicle usage data stored in said remote data storage.
